(19) United States
(12) Patent Application Publication
(10) Pub. No.: US 2004/0025035 A1
(43) Pub. Date: Feb. 5, 2004

(54) Contactless electronic identification system

(76) Inventors: Rais Jean-Claude, Delemont (CH); Kayal Abdul-Hamid, Neuchatel (CH); Desarzens Pierre, Bienne (CH)

Correspondence Address: SUGHRUE MION, PLLC, 2100 PENNSYLVANIA AVENUE, N.W., WASHINGTON, DC, 20037, US

(21) Appl. No.: 10/399,854

(22) PCT Filed: Oct. 23, 2001
(86) PCT No.: PCT/CH01/00629

(30) Foreign Application Priority Data
Oct. 23, 2000 (EP) 00203702.6

(51) Int. Cl. G06F 12/14

(52) U.S. Cl. 713/189

(57) ABSTRACT

The invention concerns a non-contact electronic identification system comprising at least a reading unit (5) and at least a data storage medium or transponder (1) adapted to be interrogated by the reading unit, said reading unit comprising security means (50, 60) for making secure access to application data (APPL. DATA i) during operations managing said application data. According to the invention the transponder (1) comprises storage means (18) including a segmented memory workspace (180) for receiving application data (APPL. DATA i) concerning a plurality of separate applications, said application data being encrypted by said reading unit (5) using at least a first encoding key before being stored in said storage means (18) of the transponder.

The present invention relates generally to a contactless electronic identification system, commonly known by the denomination “RFID system” (Radio Frequency Identification), or “CID system” (Contactless Identification). More specifically, the present invention concerns such a contactless identification system using data storage mediums, or transponders, arranged to operate with several applications. The present invention concerns in particular an electronic identification system according to claim 1.

Contactless electronic identification systems are used in various applications, particularly as identification and access authorisation systems for entry checking applications, time management applications or subscription applications, or as access systems for services requiring payment (pre- or post-payment) for cash desk or automatic machine type applications.

Typically, for each application, a distinct identification system is used. Such a system typically includes (1) data storage mediums, or transponders, carried by the users and generally taking the form of electronic cards or electronic components integrated in portable objects such as watches, (ii) read units dispersed over the various access sites (for example at the various entries to a building to which access is subject to rules), and (iii) at least one programming unit for configuring the various transponders for the application concerned.

Thus, a user wishing to access several different applications will typically have to have several identification supports adapted to each application. The consequence of this is a wasteful and inappropriate multiplication of the transponders necessary and may also lead to a risk of confusion for the user or loss of one or more transponders, which may obviously be prejudicial to the user.

It is thus desirable to propose an identification system allowing in particular the aforementioned problems to be answered, namely a multi-application identification system that requires, for a given user, only one transponder in order to access several distinct applications.

Such a multi-application identification system as well as a transponder able to operate with several distinct applications are already proposed in document WO 97/34265. The transponder used in this identification system comprises in particular storage means including a segmented memory space for receiving application data relating to a plurality of distinct applications. More specifically each memory segment includes an identification segment or tag for identifying the application to which the application data contained in the memory segment concerned relates. This tag, or “stamp”, is formed of a sequence identifying the application concerned and which is a function of the organisation level for this application in a hierarchical authorisation system.

According to the teaching of this document, it will be noted that the aforementioned organisation of data in the transponder memory involves the stored data being systematically searched (by the transponder processor or the read unit) in order to identify whether the application data belonging to a determined application are present in the transponder memory. One will understand that this solution has a particular drawback in terms of speed and facility of access to the data stored in the transponder.

According to the teaching of this document, the security of the data is further simply ensured by a transponder authentication process in the read unit, i.e. a unilateral authentication. According to this well-known authentication process, and with a view to establishing communication between a read unit and an affiliated transponder, the read unit is arranged to transmit a random number to the transponder that is encoded by the transponder by means of an encoding key then retransmitted to the read unit to be decoded by means of an encoding key which is stored in the read unit and which is identical to the transponder encoding key. If the decoding result is identical to the initially transmitted random number, communication is then established.

Although desirable, it will be noted first of all that this unilateral authentication is generally insufficient to ensure an adequate level of security. Thus, bilateral or mutual authentication should at least be implemented, i.e. authentication of the transponder by the read unit and authentication of the read unit by the transponder. However, even if such a bilateral authentication were implemented, the data subsequently exchanged between the read unit and the transponder could nevertheless be observed by third parties.

It is thus a general object of the present invention to propose an identification system particularly allowing the aforementioned problems to be answered, namely a multi-application identification system that requires, for a given user, only one transponder in order to access several distinct applications.

It is another object of the present invention to propose such a multi-application contactless electronic identification system, which is simple, quick, has a high level of security in addition to great flexibility of use.

It is a further object of the present invention also to guarantee security between the different applications, i.e. to guarantee that one application and the data relative to an application developed by a first operator or service provider cannot be visible, accessed or modified by another service provider who has developed another application to which the user has subscribed in parallel.

The present invention thus concerns a contactless electronic identification system whose features are listed in claim 1.

The present invention also concerns a method for formatting and managing data in a transponder storage means whose features are listed in claim 14.

The present invention further concerns a read unit for contactless electronic identification whose features are listed in claim 23.

In addition, the present invention concerns a transponder whose features are listed in claim 29 as well as a portable object comprising such a transponder.

Advantageous embodiments of the present invention form the subject of the dependent claims.

One advantage of the present invention lies in the fact that a user wishing to access several distinct applications, will need only a single transponder in order to access these multiple applications. According to the present invention, a user has, in particular, great flexibility of choice as regards the various applications that are offered to him.

Another advantage of the present invention lies in the fact that the security between the various applications is nonetheless guaranteed and in that the data of one application developed by a service provider is not capable of being altered by another application. The application data security is further ensured by suitable encryption of this various data, particularly on the basis of an individual unique code for each transponder, such as a unique serial number for each transponder.

According to a particularly advantageous embodiment of the present invention, the application data are stored in determined memory segments of the transponder and an additional memory segment is provided for containing directory data indicating which applications are stored in the transponder as well as their position in the memory. Consequently, access to the data is greatly facilitated.

According to yet another embodiment of the present invention, the transponder storage means further include a memory segment including data relative to a time validity of the application concerned, the read unit including clock means for determining the expiry of validity of the application concerned and allowing, if the application concerned has expired, release of the corresponding memory part of the memory space of the transponder storage means.

According to the present invention, it will be noted that the transponder does not have any particular “intelligence” so to speak. According to the invention, it is the read unit that ensures the management and security of the various applications, as well as the data encryption and decryption. It will be understood that this is a particularly important advantage in that the read unit is typically managed by the application operator and can be physically placed in perfectly controlled locations.

Other features and advantages of the present invention will appear more clearly upon reading the following detailed description, made with reference to the annexed drawings, given by way of non-limiting examples and in which:

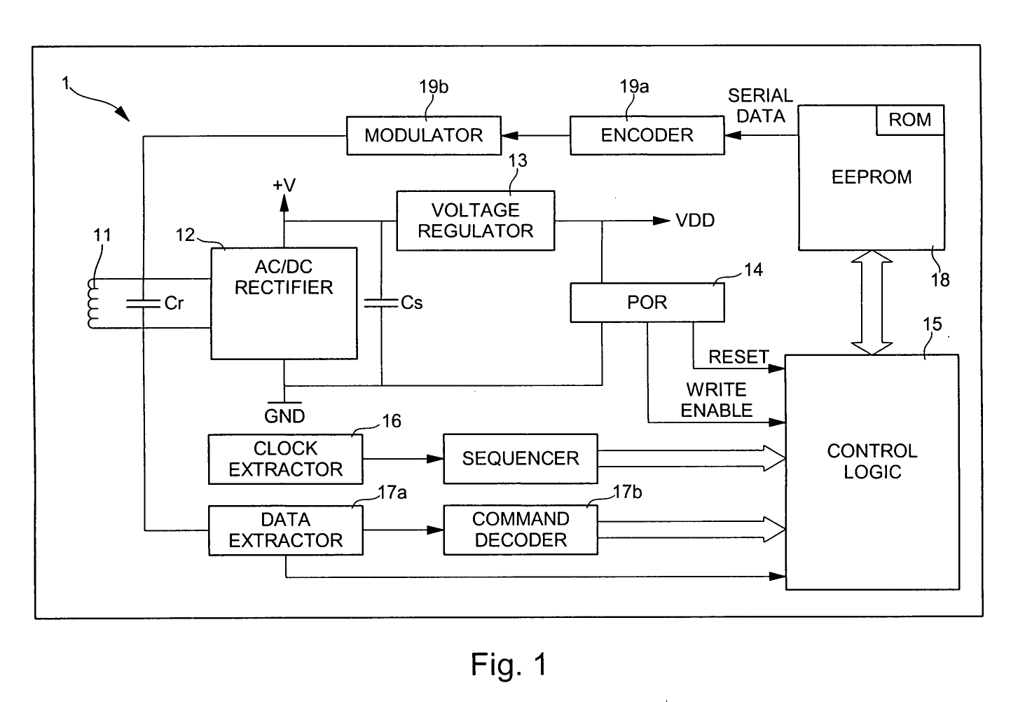

FIG. 1 shows a block diagram of a data storage medium or transponder used within the scope of the present invention;

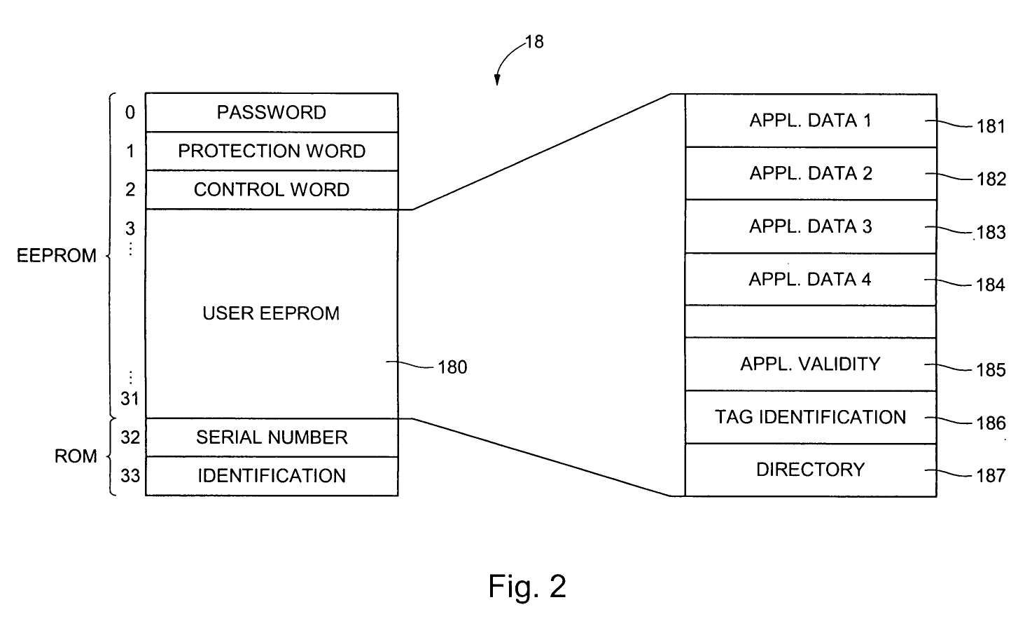

FIG. 2 shows a transponder memory architecture within the scope of the present invention;

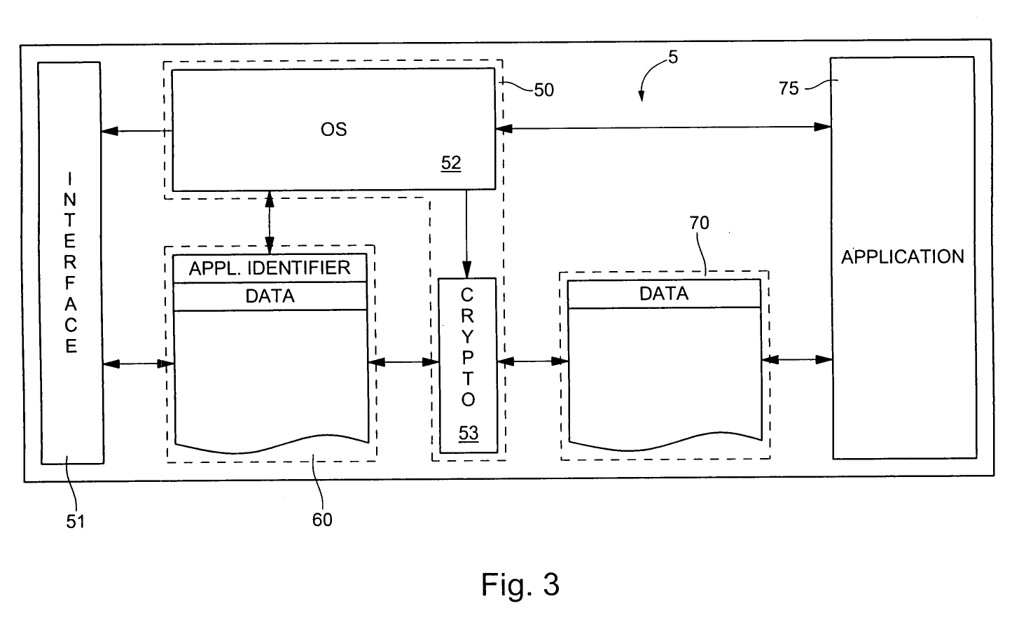

FIG. 3 shows the general architecture of a read unit according to the present invention arranged to converse with said transponder;

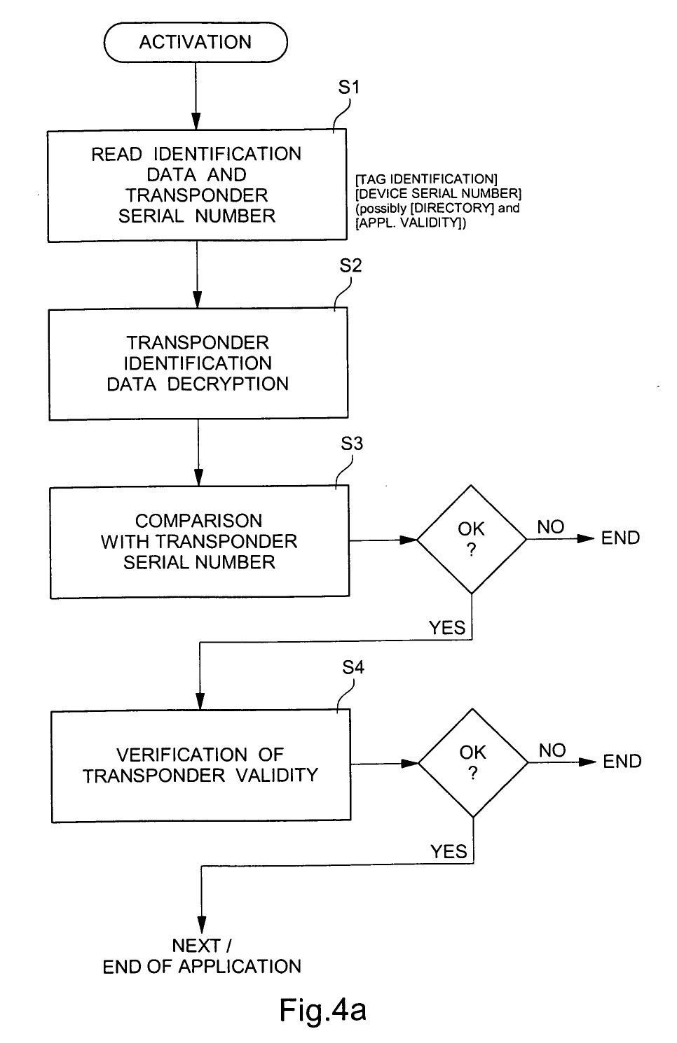

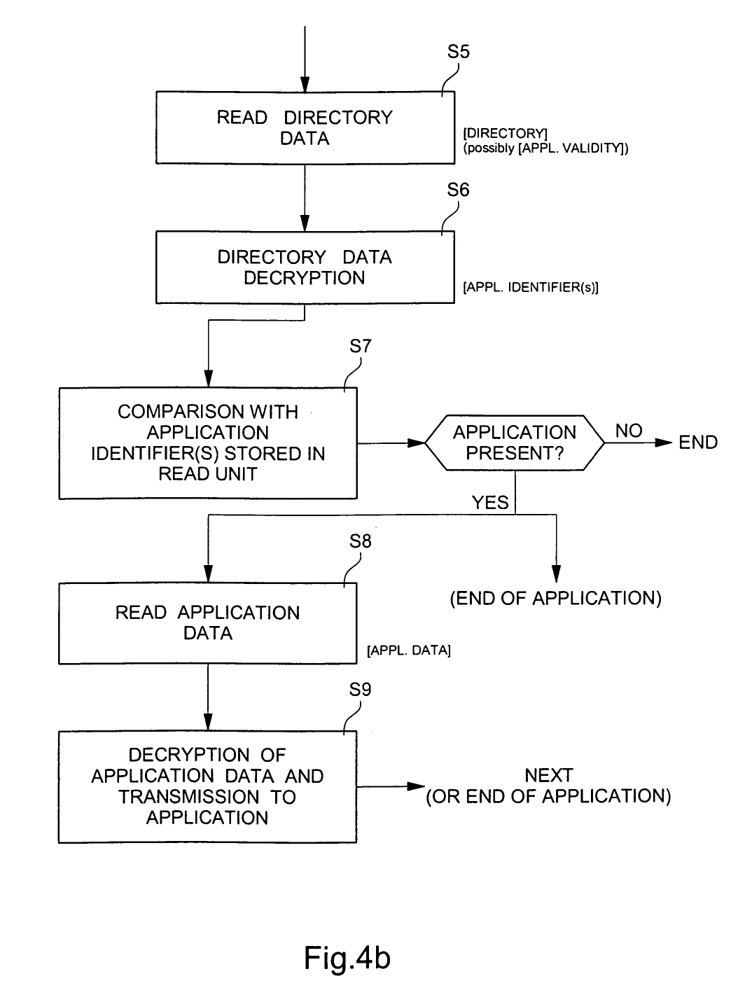

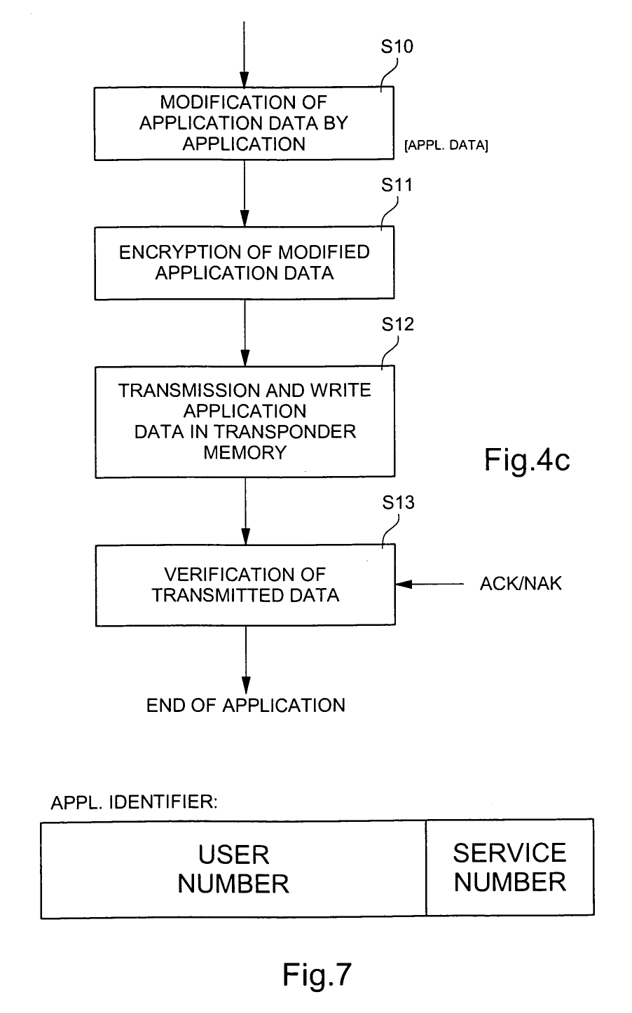

FIGS. 4a to 4c illustrate different operating phases of the read unit of FIG. 3 during communication with a transponder;

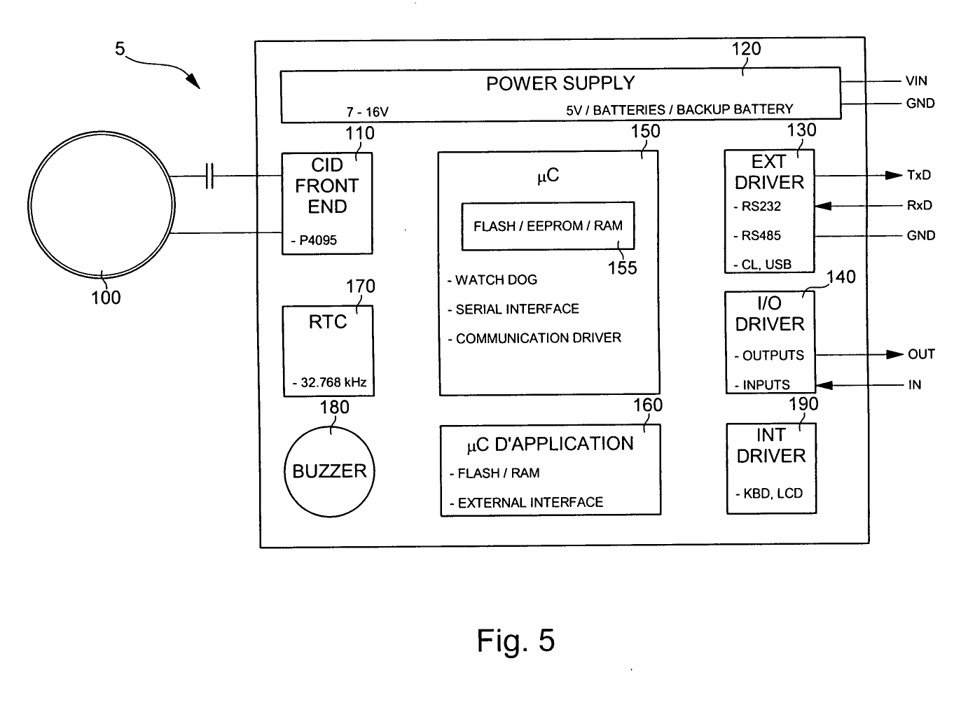

FIG. 5 shows a simplified block diagram of the read unit of FIG. 3;

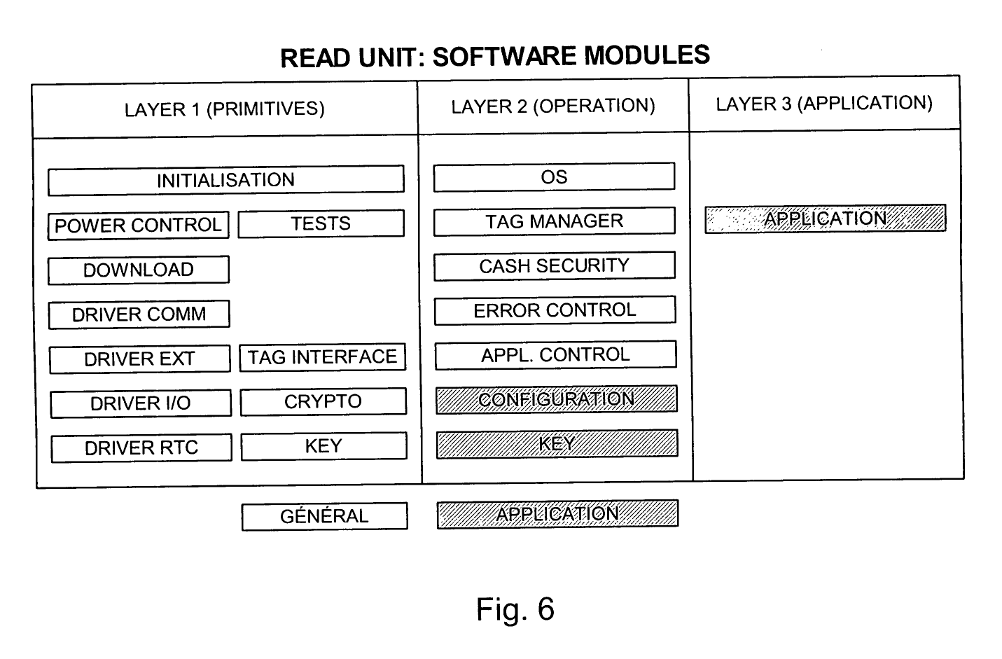

FIG. 6 shows schematically a diagram of the software modules of the read unit;

FIG. 7 illustrates schematically the structure of an application identifier within the scope of the present invention; and

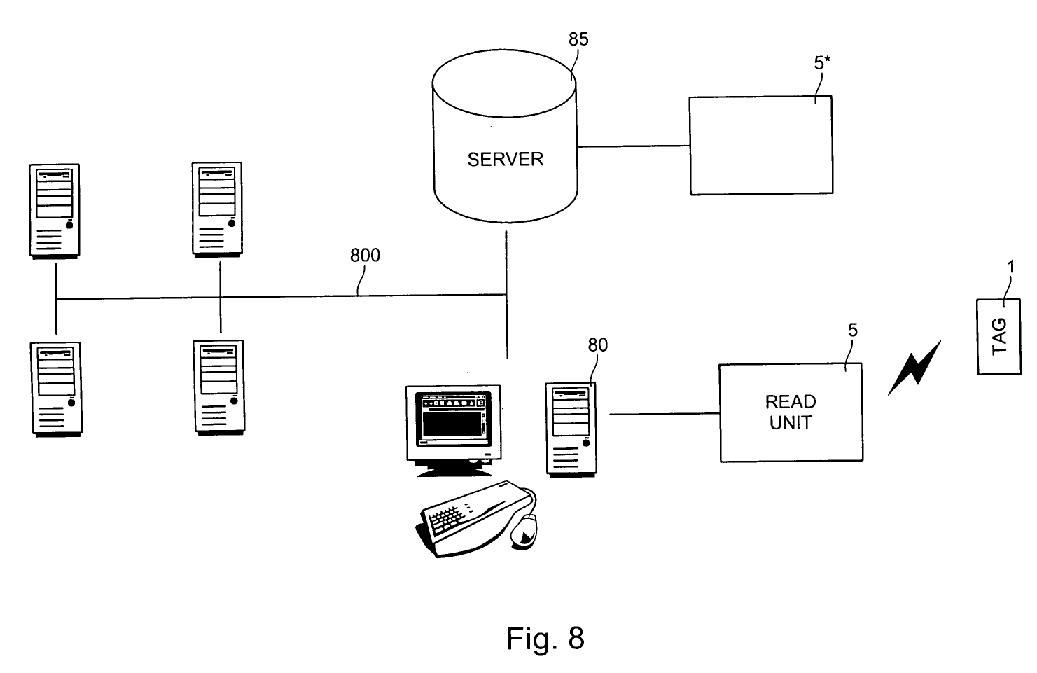

FIG. 8 illustrates a network implementation of the electronic identification system according to the present invention.

FIG. 1 shows a block diagram of a data storage medium or transponder for a contactless identification system. Such a transponder is, for example, marketed by the company EM Microelectronic-Marin SA under the reference P4150 “1 KBit READ/WRITE CONTACTLESS IDENTIFICATION DEVICE”. Reference will be made as far as necessary to the technical specifications of this circuit, which are publicly available (particularly via the site www.emmarin.ch of this company) and which are moreover incorporated herein by reference. FIG. 1 is a schematic diagram of this transponder circuit marketed by the aforementioned company. This transponder, typically arranged to operate at a frequency of the order of 125 kHz, is particularly arranged to co-operate with a read interface such as the interface marketed by the same company EM Microelectronic-Marin SA under the reference P4095 “READ/WRITE ANALOG FRONT END FOR 125 kHz RFID BASE STATION” whose publicly available technical specification is also incorporated herein by reference. It will be noted that the use of the aforementioned components is in no way limiting and that other similar components could also be used provided that they fulfil the functions that will be stated hereinafter.

The transponder, generally indicated by the reference numeral 1 in FIG. 1, is powered by the ambient electromagnetic field, which induces a voltage across the terminal of a coil 11 of the antenna circuit. This voltage is rectified by an AC/DC rectifier unit 12 and provides the supply voltage +V necessary for the device to operate. Voltage regulating means 13 in addition to a power on reset control block 14 ensure adequate initialisation of control logic 15 of the circuit. Transponder 1 further includes clock extraction means 16 for deriving a clock signal from the electromagnetic field which clocks control logic 15, data extraction means 17 for extracting modulated data on the electromagnetic field, and a command decoder block 17b. Transponder 1 further includes storage means 18, formed particularly of a reprogrammable EEPROM and a read-only ROM and associated encoding 19a and modulation 19b means for modulating and transmitting data stored in said storage means 18.

FIG. 2 shows schematically the architecture and organisation of storage means 18 of transponder 1 illustrated in FIG. 1. As already mentioned, these storage means 18 include in particular an EEPROM and a ROM. The EEPROM is formed, in a non-limiting manner of a 1024 bit EEPROM organised in thirty-two words of 32 bits (words 0 to 31 in FIG. 2). Storage means 18 further include, again in a non-limiting manner, two additional 32 bit words (words 32 and 33 in FIG. 2) laser programmed in a ROM (cf. particularly the specification of the aforementioned component P4150). These two ROM words 32 and 33 contain respectively a serial number DEVICE SERIAL NUMBER and an identification number DEVICE IDENTIFICATION that are unique, i.e. peculiar and unique to each transponder.

More specifically, the first three 32 bit words (words 0 to 2) are respectively allocated to a password designated PASSWORD, to a protection word designated PROTECTION WORD and to a control word, designated CONTROL WORD. The password PASSWORD is write protected and cannot be read from the exterior. This password PASSWORD typically has to be transmitted to the transponder if one wishes to modify the protection word PROTECTION WORD and/or the control word CONTROL WORD.

The control word CONTROL WORD defines particularly which words of the memory are read during a spontaneous or standard read operation (this operation is defined as the “Standard Read Mode” in the aforementioned specification of the product P4150), which is carried out as soon as the circuit is activated by the transmission of an ambient electromagnetic field. In particular, as described with reference to FIG. 6 of the specification of the aforementioned product P4150, bits 0 to 7 (First Word Read—FWR) and 8 to 15 (Last Word Read—LWR) of the control word CONTROL WORD define respectively the first and last words read during the standard read operation “Standard Read Mode” (hereinafter “Standard Read”), bit 16 (Password Check On/Off) defines whether or not a check of the password PASSWORD has to be carried out, bit 17 (Read After Write On/Off) defines whether or not re-reading has to be carried out after a write operation in memory and bits 18 to 31 are typically available for the user.

The protection word PROTECTION WORD defines which words in the memory are read and/or write protected. Thus, as described in the specification of the aforementioned product P4150, bits 0 to 7 (First Word Read Protected) and 8 to 15 (Last Word Read Protected) of the protection word PROTECTION WORD define respectively the first and last read protected words, and bits 16 to 23 (First Write Inhibited) and 24 to 31 (Last Word Write Inhibited) define respectively the first and last write protected words.

The memory space formed in this example of the twenty-nine memory words 3 to 31 of the EEPROM (in this example 928 bits) is available particularly for the user and forms a user memory space 180 designated USER EEPROM. It will be noted that complementary data relative to the transponder can also be stored in this memory space. This complementary data can for example include the transmission date and the validity duration of the transponder, a signature ensuring the origin of the transponder, or other data relating to the identification and validity of the transponder itself. In particular, memory space 180 includes a memory segment 186 containing data designated TAG IDENTIFICATION for checking that the transponder is affiliated with the identification system, i.e. that it is actually a transponder managing several applications according to the present invention, as well as the time validity of the transponder and its origin (signature).

According to the present invention, and within the scope of a non-limiting example based on the aforementioned product, the user memory space USER EEPROM 180 is used, in particular, for managing a plurality of distinct applications, designated APPL1, APPL2, etc. More specifically, as illustrated schematically in FIG. 2, memory space USER EEPROM 180 is segmented into a plurality of memory segments 181, 182,183, 184, in this non limiting example, four in number, capable of containing application data designated APPL. DATA i, i=1 to 4, peculiar to various applications, the remaining memory space preferably being used for storage additional data that will be presented subsequently. At least one memory segment is attributed to each application. However, if necessary, several memory segments can be allocated to one application. It will be understood for example that memory segments 181 and 182 could be allocated to a first application (or a first group of applications) of a first operator, and segments 183 and 184 to applications of two other operators.

Within the scope of the present invention, it will be noted that the notion of application does not necessarily imply that this application is provided for only one type of service. Given the memory space available, it will easily be understood that the application data of several applications of the same operator can be stored in a single memory segment. In other words, “application” will mean a group of applications managed by one operator and can include one or more applications, or more exactly sub-applications. It will be stressed that each application operator will in practice have one or several memory segments for managing the group of applications peculiar to it.

Preferably, the memory space further includes an additional memory segment 187 to contain directory data designated DIRECTORY providing an indication of the applications stored in the transponder and their memory position. More specifically, this directory data designated DIRECTORY includes data (application identifiers or describers, hereinafter APPL. IDENTIFIER) relating to the applications used and stored in the memory space. A distinct application identifier, whose features will be presented hereinafter, is associated with each application.

The remaining memory words are preferably reserved for storing complementary data relating to the transponder (as mentioned above) or to the stored applications. In particular, the complementary data relating to the applications can advantageously include data 185 (designated APPL. VALIDITY) relating to the validity of the stored applications, for example the length of validity of the application(s) concerned. As will be seen subsequently, this validity data can advantageously allow the release of part of the memory space allocated to an application that has expired.

According to the present invention, application data APPL. DATA i, and preferably, directory data DIRECTORY, transponder identification data TAG IDENTIFICATION and the application validity data APPL. VALIDITY, are encrypted at least by means of a first encoding key, which is only known and visible to the read unit.

According to the invention, it will be noted that the data security and confidentiality is strictly speaking ensured by the read unit of the identification system. The data stored in the transponder is perfectly legible during communication between the transponder and the read unit but only in encrypted form, the encryption and decryption of said data being carried out by the read unit only, by means of one or several encoding keys, as will be seen hereinafter.

With reference once again to FIG. 2, it will be noted that the programming of words 0 to 2 (PASSWORD, PROTECTION WORD, CONTROL WORD) is typically carried out by the read unit manufacturer. The two ROM words 32 and 33 are programmed during manufacture by the transponder manufacturer. The remaining memory words are programmed particularly (but not solely) by the user (in particular by the operator(s) or application provider(s)), programming of certain memory words (such as identification data TAG IDENTIFICATION or the directory data DIRECTORY) being under the read unit's control.

Control word CONTROL WORD can advantageously be defined such that the transponder identification data TAG IDENTIFICATION (memory segment 186), directory data DIRECTORY (memory segment 187) and the serial number DEVICE SERIAL NUMBER and the identification number DEVICE IDENTIFICATION of the transponder (ROM words 32 and 33) are automatically read during the aforementioned standard read operation. Likewise, validity data APPL. VALIDITY of memory segment 185 could also be automatically transmitted by the transponder. In such case, the data should preferably be organised such that the memory positions of said data are contiguous as illustrated schematically in FIG. 2.

FIG. 2 shows schematically the structure of an application identifier APPL.IDENTIFIER within the scope of the present invention. This application identifier APPL.IDENTIFIER is a word or code of a determined length (for example a 32 bit word) for identifying the application concerned and the operator of such application. As illustrated schematically, this identifier is preferably formed of a number of the operator concerned (USER NUMBER—e.g. a 24 bit code) followed by an application or service number of the operator (SERVICE NUMBER—e.g. an 8 bit code). In practice, the read unit manufacturer provides each operator of the system with a unique client number and allocates him, depending on his needs, the desired number of applications. Each system operator thus has, for each of his applications, an application identifier which is peculiar to him and which cannot be used by another system operator. In this way, the authorisation system used within the scope of the present invention allows a clear and total division between each operator as well as between each application.

As briefly explained hereinbefore, each application (of the same operator or different operators) is associated with a distinct application identifier APPL. IDENTIFIER. This identifier is stored, with any other application identifiers in a specific memory segment, distinct from the memory segments for storing the application data, namely the directory segment (segment 187 in FIG. 2) containing the directory data DIRECTORY. This directory data DIRECTORY, on the one hand, identifies which applications are stored in the transponder, and on the other hand, specifies which memory segment(s) the application data of such applications are stored in. This directory data DIRECTORY greatly facilitates the identification and localisation of the application data stored in the transponder. Consequently, it is no longer necessary to search through all the stored data to check whether the data peculiar to a determined application is present.

With reference now to FIG. 3, the general architecture of a read unit according to the present invention will be described. “Read unit” means both a unit arranged to allow the transponder to be read only and a unit arranged to allow a transponder to be both read and programmed. Generally, reference can again be made to the specification of the aforementioned product P4150 to obtain a general description of a read unit arranged to carry out transponder read and/or write operations.

FIG. 3 illustrates schematically the architecture and organisation of the read unit according to the present invention, generally indicated by the reference numeral 5. It will be noted that the architecture of this read unit is essentially formed of three distinct parts, namely (1) a protected management module (or operating system) 50, (2) a protected memory 60, and (3) an application memory 70.

Management module 50 is programmed and encoded by the read unit manufacturer and is not accessible by the application. It is in connection with a read/write interface 51 of the transponder, control and processing means 52 and encrypting/decrypting means 53 for encrypting, respectively decrypting, data from one or more encoding keys. It will be noted already here that a basic encoding key used for encrypting data is advantageously derived from the unique serial number of each transponder (or any other code peculiar and unique to each transponder). Consequently, the data encryption in the transponder is unique for each transponder, thus preventing a transponder containing a simple copy of data of another transponder of the system from being used. Additional encoding keys are preferably used to carry out encryption of this data. It will be noted that management module 50 also performs a check of the conformity of the transponder with the system (particularly a check of its serial number and validity) as well as managing transactions with the transponder (particularly management of its memory).

Protected memory 60 is used for encrypting data and managing the transponder memory. This protected memory is not accessible through the application. It includes various memory fields particularly for allowing storage of data relating to the transponder serial number, its validity, and to the application data.

Application memory 70 is made available to application 75 and contains the data concerning it. In particular, it includes memory fields particularly intended for storing data relating to the identification of the transponder (particularly its serial number) and unencrypted application data.

Preferably, protected part 50, 60 of the read unit includes the application identifier(s) of the applications for which the read unit is configured. It will be noted that this or these application identifiers could alternatively be stored in a non-protected memory part.

FIG. 5 shows a general block diagram of the read unit whose general architecture was presented hereinbefore. Read unit 5 includes particularly an antenna 100 for interrogating the system transponders remotely, a CID front-end part 110 for controlling antenna 100, a power supply 120 (internal or external), an external connection interface 130 (typically including RS232, RS485 and/or USB connectors), an input/output interface I/O 140, and a microcontroller 150 including in particular storage means 155 (FLASH, EEPROM, RAM), a watch-dog, a serial interface, and communication drivers.

As already mentioned, the CID front-end part 110 is based on a circuit marketed by EM Microelectronic-Marin SA under the name P-4095 “READ/WRITE ANALOG FRONT END FOR 125 kHz RFID BASESTATION” whose public technical specification is incorporated herein by reference. This part 110 and antenna 100 form the write/read interface 51 (FIG. 3) with the transponder.

By way of option, read unit 5 can include an application microcontroller 160 with additional memory, a real time clock RTC 170, a buzzer 180, and an internal control interface 190 for example for a keyboard and/or an LCD display.

In particular, real time clock RTC 170 can be used to determine the expiry of the validity of a used application (on the basis of aforementioned validity data APPL. VALIDITY) for example with a view to releasing memory space in the transponder.

By way of a practical embodiment, read unit 5 can be provided as an extension of a computer terminal (in the form of an extension card or peripheral unit) or in the form of a stand alone unit, i.e. a unit that does not require any specific interface with a computer terminal.

Moreover, the read unit can perfectly well be connected to a local area or wide area computer network and form a secure access interface for accessing data stored in a network server. It will be noted that access systems for computer networks, including a smart card reader connected to a computer terminal to read the personal access keys of a user stored on the smart card, are already known. The identification system according to the present invention can thus be used, within the scope of such an application, in place of the reader and the smart card.

A particularly advantageous network implementation of the identification system according to the present invention is illustrated in FIG. 8. According to this implementation, at least one read unit 5 is connected to a computer network (local area or wide area) 800 via a computer terminal 80. At least one server 85 accessible from computer terminal 80 is also connected to network 800, this sever 85 containing for example a centralised data base to which a user carrying a transponder 1 according to the present invention wishes to access. Advantageously, the server itself is fitted with or connected to a separate unit, designated 5*, whose functions are substantially similar to read unit 5, ignoring the read/write interface with the transponder. This second unit 5* can advantageously contain a common application identifier with read unit 5 of transponder 1 (this application identifier being able to be different from the application identifier used to ensure communication between read unit 5 and transponder 1). According to this implementation, an authentication process is provided between read unit 5 of the transponder and unit 5* connected to the server.

According to this particular implementation, it will also be noted that additional unit 5* connected to server 85, can be arranged to ensure encryption of the data transmitted to read unit 5.

By means of the implementation of FIG. 8, secure access to data stored by server 85 can thus be ensured, at a first level, by authentication between transponder 1 and read unit 5, and, at a second level, by authentication between read unit 5 and unit 5* connected to the server. As will be seen hereinafter, a third security level can be achieved by providing read unit 5 and/or transponder 1 with means for entering a personal identification code (PIN) or means for measuring a biometric parameter.

Consequently, it will be understood that access to the data stored in server 85 requires the authorisation of a multitude of successive mechanisms, interconnected like links in a chain.

It will further be noted that antenna 100 can be arranged in direct proximity to the read unit or in a position far from the read unit, this latter solution advantageously allowing the read unit to be arranged in a protected place out of reach of any users.

With reference to FIGS. 3 and 5, it will be noted that the functions of management control module 50 are performed by microcontroller 150. Storage means 155 of microcontroller 150 are segmented in order to fulfil the functions of protected memory 60 and application memory 70.

FIG. 6 briefly summarizes the various software modules implemented in microcontroller 150 of the read unit. In the first place, a first layer, or primitives, performs the basic functions of various components of the read unit, namely:

Initialisation: Initialisation of the processor and the general modules. Initialisation of the application occurs by itself via the management module.

Power control: control and management of power consumption.

Download: programs allowing programming of the configuration and application keys (EEPROM) and the protection thereof.

Driver COMM: communication driver between the read unit and the application (the application can lie in the internal or external memory or in another processor).

Driver EXT: communication driver with the external world (asynchronous or synchronous serial interface).

Driver I/O: driver for the parallel inputs and outputs (keys and relays).

RTC driver: RTC control (Real Time Clock)

Tests: test programs for power on reset and the client service.

TAG interface: TAG (transponder) read and write control.

Crypto: encryption programs. These algorithms use encryption keys defined fixedly or by the application.

Key: encryption keys of the read unit.

A second layer, or operating layer, actually performs the operation and management of the application or applications, namely, the following functions:

OS: operating system that allows the application to be started and managed.

TAG manager: multi-application management algorithms.

Cash security: security algorithms for transactions and data

Error control: management of errors.

Appl. control: control of the application.

Configuration: configuration of the application.

Key: application encryption keys.

Finally, a third layer, or application layer, performs the functions peculiar to each application, this layer being able to reside in or outside the protected memory, and be resident or external to the actual read unit.

Management of an application by the read unit can occur in several phases depending on the type of application and transaction to be carried out:

identification: From the aforementioned “Standard Read”, the serial number contained in the transponder identification data TAG IDENTIFICATION is decrypted and compared to the transponder serial number DEVICE SERIAL NUMBER, then transmitted to the application. This phase is sufficient for applications only requiring identification (in the case of a centralised data base for example).

read: Upon request for the application, the read unit reads the memory zone dedicated to this application (in accordance with the “Selective Read” process presented in the specification of the EM product P-4150), and transmits the data to it after decryption. In case of subscription type application, this phase ends the transaction.

write: The read unit writes the data modified by the application in the transponder memory. The proper progress of this operation is checked by decoding an acknowledgment ACK transmitted by the transponder.

verification: The data is reread and compared to the original data.

In the present case, the communication between the read unit and the transponder is carried out in accordance with the standard read process (“Standard Read”), selective read process (“Selective Read”) and write process which are fully described in the specification of the aforementioned product P4150. These specific processes are of course in no way limiting to the application of the present invention and are given here solely by way of example.

It will simply be mentioned here that the standard read operation (“Standard Read”) essentially consists of a transmission, from the transponder to the read unit, of memory words defined by the first and last memory words FWR and LWR defined in control word CONTROL WORD of the transponder as mentioned hereinbefore.

By way of example, the standard read operation could consist in a transmission of the transponder identification data TAG IDENTIFICATION (memory segment 186), i.e. the transmission of encrypted identification data including in particular the encrypted serial number, the signature and the validity of the transponder. This data is stored in the memory of the read unit.

The aforementioned standard read operation could be followed by a selective read request (“Selective Read”) for the purpose of requesting an additional transmission by the transponder of complementary data, particularly the content of the memory word relating to the unencrypted transponder serial number DEVICE SERIAL NUMBER (word 32 in FIG. 2).

The selective read operation (“Selective Read”) is also fully described in the technical documentation of the aforementioned product P4150. One need only say that the selective read operation (“Selective Read”) is used for reading other data than the data defined by the control word CONTROL WORD (words between FWR and LWR in “Standard Read”). In order to enter selective read mode (“Selective Read”), the read unit has to transmit a command (designated “Receive Mode Pattern” RM) during a read window (designated “Listen Window” LIW) in order to activate the transponder reception mode. A selective read command (“Selective Read Mode Command”) is then transmitted by the read unit, followed by the addresses of the first and last memory words that have to be read. For the rest, the selective read mode behaves like the aforementioned standard read mode (“Standard Read”). The selective read request (“Selective Read”) can also, if necessary, be used to request the transmission of directory memory words DIRECTORY (memory segment 187 in FIG. 2).

By way of simplification, as already mentioned, the standard read operation could advantageously consist of a transmission of all of the application validity data APPL. VALIDITY, the transponder identification data TAG IDENTIFICATION, the directory data DIRECTORY and the serial number DEVICE SERIAL NUMBER stored in the ROM, this data being then placed contiguously in the memory.

Generally, the communication process between the transponder and the read unit begins by identification of the transponder's conformity with the system, i.e. verification of its affiliation with the multi-application system according to the invention and the validity of this affiliation. As illustrated in the flow chart of FIG. 4a, this identification phase preferably consists in a read operation (S1), following activation of the transponder, of identification data TAG IDENTIFICATION stored in memory segment 186 of the transponder (cf. FIG. 2) and of the transponder serial number DEVICE SERIAL NUMBER stored in the ROM (word 32 in FIG. 2). Again, this read operation of the aforementioned data can be carried out, in the present case, in accordance with the standard read process (“Standard Read”), completed, if necessary, by a selective read request (“Selective Read”).

Preferably, the identification data TAG IDENTIFICATION includes an image of the transponder serial number DEVICE SERIAL NUMBER encoded by means of a specific encoding key unique to the transponder as well as an item of data concerning the time validity of the transponder. The transponder identification process thus continues (S2) with a decrypting step of identification data TAG IDENTIFICATION, then (S3) a comparison of the decrypted data with the serial number and (S4) an examination of the transponder's validity. If the results of these checks are positive, the communication process can proceed. In the opposite case, the process is interrupted. It will be noted again that the identification phase can be sufficient in certain applications, such as access control applications where only the identification of the transponder is required to authorise access.

By way of complement, the identification process can advantageously implement a mutual authentication process between the read unit and the transponder. Such authentication processes are well known to those skilled in the art and will consequently not be described here.

The aforementioned identification phase is normally followed by a read phase. This read phase will now be briefly described with reference to the flow chart of FIG. 4b. The communication process thus continues (S5) by reading the directory data DIRECTORY stored in the transponder. It will again be noted that this directory data DIRECTORY can be read initially at the aforementioned step S1 or alternatively form the subject of a selective read request. At step S6, this directory data DIRECTORY is decrypted by the read unit in order to extract therefrom and identify the various aforementioned application identifiers indicating for which applications the transponder is configured. There then follows (S7) a comparison of the application identifiers stored by the transponder and the application identifier(s) loaded by the read unit, i.e. the application identifiers for which the unit is configured. If one of the applications for which the read unit is configured is present in the transponder memory, the communication process can proceed. In the opposite case, the process is of course interrupted. It goes without saying that this process is repeated for each application for which the read unit is configured.

It will further be noted that the aforementioned steps S5 to S7 are preferably also provided for reading, decrypting and checking the validity data (APPL. VALIDITY) of the transponder applications, and, in the event that the application considered is not longer valid, to free the memory space occupied by this application and interrupt the communication process (or to undertake the steps necessary in order to update the data relating to this application).

The communication process proceeds normally by reading the application data peculiar to the application concerned. It will again be noted that the application data memory position of the application concerned (namely the memory segment or segments in which this data is stored), or more exactly the memory address of this data, is contained in directory data DIRECTORY, which were decrypted at step S7. Step S8 thus typically consists, in the present case, in a selective read request (“Selective Read”) of the data peculiar to the application concerned. This application data is again decrypted (step S9) and transmitted to the application.

It will be noted that the communication process can be interrupted, in certain applications, either at the end of step S7, or at the end of step S8. Certain applications can in fact be interrupted as soon as the presence of the application concerned has been able to be detected or as soon as certain data peculiar to this application have been loaded by the read unit (without requiring any subsequent modification of the data).

The flow chart of FIG. 4c shows the final phase of the communication process which normally consists (S10) of a modification by the application concerned of the loaded application data, followed by (S11) the encryption of the modified data and (S12) writing them in the transponder memory. A final verification step (S13) can also typically be carried out in order to ensure that the data have been correctly transmitted. It will noted, in this regard, that the aforementioned product P4150 used as a transponder example within the scope of the present invention, is arranged to transmit an acknowledgment ACK or NAK depending upon whether or not the transmitted data satisfy tests carried out by the transponder (such as parity tests as fully discussed in the technical specification of this product). In the event of an error, the write process is repeated.

As briefly stated hereinbefore, the encryption and decryption of the transponder data is carried out at least by means of a first encoding key. Preferably, a basic key derived from the unique transponder serial number is used. An additional encoding key preferably derived from the data memory position can be used to encrypt and decrypt the application data stored in the application segments (segments 181 to 184 in FIG. 2). It will also be understood that an encoding key derived from the application identifier can be used to encrypt and decrypt the same application data. It will also be understood that the read unit and application operator is perfectly capable of using other additional encoding keys to encrypt certain data peculiar to his application. It will also be noted that various encrypting algorithms can be envisaged such as algorithms based on or derived from standards such as DES or triple DES.

By way of advantageous complement, one could envisage providing the read unit and/or the portable object in which the transponder is incorporated with means for entering a personal identification number (or PIN) or even with means for measuring a biometric parameter, such as a fingerprint or a voiceprint for example. These means are well known to those skilled in the art and will consequently not be described here. It will be noted that such means are particularly advantageous for certain types of application, such as medical applications where the security required to ensure confidentiality of the data exchanged between a patient and his doctor is primordial. This is also true for banking applications for example. By way of example, reference could be made to document GB 2 181 582 (or to the corresponding document WO 87/02491) for a possible implementation of such means.

As already mentioned hereinbefore, the transponder can easily be incorporated in a portable object such as a wristwatch. By way of example, the SWATCH company (registered trademark) markets such a wristwatch by the name of ACCESS, this wristwatch being able to be used within the scope of the identification system according to the invention after formatting the transponder memory in accordance with the foregoing. Other embodiment examples of such portable objects are known to those skilled in the art. One could, for example, refer to document EP 0 844 685 in the name of Eta SA Fabriques d'Ebauches, which shows an advantageous variant of the aforementioned wristwatch.

It will be understood that various modifications and/or improvements obvious to those skilled in the art can be made to the embodiments described in the present description without departing from the scope of the invention defined by the annexed claims. In particular, it will be recalled that the products P4150 and P4095 to which reference is made in the present invention, constitute only possible examples of products able to be used within the scope of the present invention. Other equivalent solutions could perfectly well be used or envisaged. By way of improvement, one could for example use a multi-application transponder of the type described in European Patent Application EP 1 087 332 in the name of EM Microelectronic-Marin SA. One could also use a different communication frequency to the frequency of 125 kHz used by the aforementioned components. Other commonly used frequencies are for example 13.56 MHz and 2.4 GHz. It will be noted finally that the transponders of the system according to the invention can be of the passive or active type, the passive type being preferred for reasons of simplicity and lifetime.

1. Contactless electronic identification system comprising at least one read unit (5) and at least one data storage unit or transponder (1) capable of being interrogated by said read unit (5),
this transponder including storage means (18) including a segmented memory space (180) for receiving application data (APPL. DATA i) relating to a plurality of distinct applications (APPL. i),
the read unit (5) including security means (50, 60) for securing access to said application data (APPL. DATA i) during management operations of said application data,
characterised in that said application data (APPL. DATA i) is encrypted by said read unit by means of at least a first encoding key prior to being stored in said storage means (18) of the transponder (1).

2. System according to claim 1, characterised in that said read unit (5) is arranged to manage at least a first determined application from among the plurality of distinct applications, said security means of the read unit (5) comprising encrypting means (53) for encrypting the application data relating to said first application prior to storage thereof in said transponder (1), identification means (52) for checking whether application data relating to this first application is stored in said transponder (1) and decrypting means (53) for decrypting application data relating to the first application stored in said transponder (1).

3. System according to claim 2, characterised in that said memory space (180) of the storage means (18) is divided into a plurality of memory segments (181, 182, 183,184) each for storing application data (APPL. DATA), and an additional memory segment (187) for storing directory data (DIRECTORY) containing an indication of each application stored in said transponder.

4. System according to claim 3, characterised in that each application is associated with a distinct application identifier (APPL. IDENTIFIER), in that said directory data (DIRECTORY) stored in said storage means (18) include the application identifier of the application concerned as well as the memory position of the application data relating to the application concerned, and in that the read unit (5) includes at least the application identifier associated with a determined application from among said plurality of distinct applications, said identification means (52) being arranged to check the presence of this application identifier in said directory data (DIRECTORY).

5. System according to claim 1, characterised in that said application data (APPL. DATA i) is encrypted and decrypted by means of at least one basic encoding key derived from a code that is peculiar and unique to each transponder, such as a unique transponder serial number (DEVICE SERIAL NUMBER).

6. System according to claim 5, characterised in that said application data (APPL. DATA i) is further encrypted and decrypted by means of an additional encoding key derived from the memory position of said application data.

7. System according to claim 4, characterised in that said application data (APPL. DATA i) is particularly encrypted and decrypted by means of an encoding key derived from the application identifier (APPL. IDENTIFIER) of the application concerned.

8. System according to any of claims 1 to 7, characterised in that said memory space (180) further includes a memory segment (185) including data (APPL. VALIDITY) relating to a time validity of the application concerned, and in that said read unit (5) includes clock means (170) for determining the expiry of validity of the application concerned and for freeing, if the application concerned has expired, the corresponding memory part of the memory space (180) of the transponder storage means (18).

9. System according to any of claims 1 to 7, characterised in that said memory space (180) further includes a memory segment (186) including transponder identification data (TAG IDENTIFICATION) for checking conformity of the transponder with said identification system.

10. System according to any of claims 1 to 7, characterised in that said security means (50, 60) of the read unit (5) further include means for entering a personal identification code or means for measuring a biometric parameter.

11. System according to any of claims 1 to 7, characterised in that said transponder (1) is incorporated into a portable object and in that the portable object includes means for entering a personal identification code or means for measuring a biometric parameter to protect access to said application data stored in said transponder (1).

12. System according to any of claims 1 to 7, characterised in that said read unit (5) is connected to a local area or wide area computer network (800) to authorise access to data stored in a server (85) of said network.

13. System according to any of claims 1 to 7, characterised in that said read unit (5) is connected to a local area or wide area computer network (800) to authorise access to data stored in a server (85) of said network and in that said server is fitted with an additional unit (5*) having similar functions to said read unit (5), this additional unit (5*) and said read unit (5) being arranged to authenticate each other.

14. Method for formatting and managing data in storage means (18) of a data storage unit or transponder (1) of a contactless electronic identification system,
this method including in particular an initial segmentation step of a memory space (180) of said transponder storage means (18) into a plurality of memory segments (181, 182, 183, 184) to receive application data (APPL. DATA i) relating to a plurality of distinct applications (APPL. i),
this method being characterised in that it further includes the following steps:
encrypting, by means of at least one first encoding key, application data of a least a first determined application from among said plurality of distinct applications;
transmitting encrypted application data to said transponder; and
storing said encrypted application data in at least one of said memory segments.

15. Method according to claim 14, characterised in that it further includes the following steps:
verification (S1, S2, S3) that said transponder (1) belongs to said electronic identification system;
if the transponder forms part of said electronic identification system, verification (S5, S6, S7) of the presence, in said transponder (18) storage means, of the application data of said at least first determined application; and
if such application data is present, reading (S8) then decrypting (S9), by means of at least said first encoding key, of the application data of said first determined application.

16. Method according to claim 14, characterised in that said memory space (180) of the storage means (18) is divided into a plurality of memory segments (181, 182, 183, 184) each for storing application data (APPL. DATA i), and an additional memory segment (187) for storing directory data (DIRECTORY) containing an indication of each application stored in said transponder.

17. Method according to claim 16, characterised in that each application is associated with a distinct application identifier (APPL. IDENTIFIER), and in that said directory data (DIRECTORY) stored in said storage means (18) include the application identifier of the application concerned.

18. Method according to claim 14, characterised in that said application data (APPL. DATA i) is encrypted and decrypted by means of at least one basic encoding key derived from a code peculiar and unique to each transponder, such as a unique transponder serial number (DEVICE SERIAL NUMBER).

19. Method according to claim 18, characterised in that said application data (APPL. DATA i) is further encrypted and decrypted by means of least one additional encoding key derived from the memory position of said application data.

20. Method according to claim 17, characterised in that said application data (APPL. DATA i) is particularly encrypted and decrypted by means of an encoding key derived from the application identifier (APPL. IDENTIFIER) associated with each application.

21. Method according to any of claims 14 to 20, characterised in that said memory space (180) further includes a memory segment (185) including data (APPL. VALIDITY) relating to a time validity of the application concerned, the method further including the following steps, after verification of the presence of the application data of said at least first application:
verification of the expiry of validity of said first application; and
if said first application has expired, deletion of the application data of said first application in order to free the corresponding memory part of said memory space of the transponder storage means (18).

22. Method according to any of claims 14 to 20, characterised in that access to said application data (APPL. DATA i) stored in said transponder (1) is protected by a personal identification code or measurement of a biometric parameter.

23. Read unit (5) for contactless electronic identification of at least one data storage unit or transponder (1) including storage means (18), this read unit including a read/write interface (51) for conversing without contact, with said transponder (1),
said storage means (18) including a memory space (180) segmented into a plurality of memory segments (181, 182,183, 184) for receiving application data (APPL. DATA i) relating to a plurality of distinct application data (APPL. i),
characterised in that the read unit further includes:
encrypting means (53) for encrypting application data by means of at least a first encoding key prior to transmission and storage thereof in said transponder; and
decrypting means (53) for decrypting application data stored in said transponder after it has been read.

24. Read unit according to claim 23, characterised in that it is arranged to manage at least a first determined application from among said plurality of distinct applications, and in that it further includes identification means (52) for checking whether application data relating to said first determined application is stored in said transponder.

25. Read unit according to claim 24, characterised in that said memory space (180) of the storage means (18) is divided into a plurality of memory segments (181, 182, 183, 184) each for storing application data (APPL. DATA), and an additional memory segment (187) for storing directory data (DIRECTORY) containing an indication of each application stored in said transponder,
in that each application is associated with a distinct application identifier (APPL. IDENTIFIER),
in that said directory data (DIRECTORY) stored in said storage means (18) include the application identifier of the application concerned, in that the read unit (5) includes at least the application identifier associated with a determined application from among said plurality of distinct applications, said identification means (52) being arranged to verify the presence of said application identifier in said directory data (DIRECTORY).

26. Read unit according to any of claims 23 to 25, characterised in that it includes:
a hardware part (50) including said read/write interface (51), said encrypting and decrypting means (53), and data processing means (52) for processing said application data;
a first memory part (60), called the protected memory, arranged to store, at least temporarily and in encrypted form, the application data (APPL. DATA i); and
a second memory part (70), called the application memory, arranged to store, at least temporarily and in decrypted form, said application data (APPL. DATA i).

27. System according to any of claims 23 to 25, characterised in that said memory space (180) further includes a memory segment (185) including data (APPL. VALIDITY) relating to a time validity of the application concerned, and in that the read unit (5) includes clock means (170) for determining the expiry of validity of the application concerned and freeing, if the application concerned has expired, the corresponding memory part of the memory space (180) of the transponder storage means (18).

28. Read unit according to any of claims 23 to 25, characterised in that it further includes means for entering a personal identification code or means for measuring a biometric parameter to prevent unauthorised access to the application data stored in said transponder.

29. Transponder for contactless electronic identification system, said transponder including in particular storage means (18) comprising a memory space (180) segmented into a plurality of memory segments (181, 182, 183, 184) for receiving application data (APPL. DATA i) relating to a plurality of distinct applications,
characterised in that said application data is stored in encrypted form,
and in that said memory space (180) further includes an additional memory segment (187) for storing directory data (DIRECTORY) including an indication of each application stored in said transponder.

30. Transponder according to claim 29, characterised in that each application is associated with a distinct application identifier (APPL. IDENTIFIER), and in that said directory data (DIRECTORY) stored in said storage means (18) include the application identifier of the application concerned as well as the memory position of the application data relating to the application concerned.

31. Transponder according to claim 28, characterised in that said application data (APPL. DATA i) is encrypted by means of at least one basic encoding key derived from a code that is peculiar and unique to each transponder, such as a unique transponder serial number (DEVICE SERIAL NUMBER).

32. Transponder according to claim 31, characterised in that said application data (APPL. DATA i) is further encrypted by means of least one additional encoding key derived from the memory position of said application data.

33. Transponder according to claim 30, characterised in that said application data (APPL. DATA i) is in particular encrypted by means of an encoding key derived from the application identifier (APPL. IDENTIFIER) of the application concerned.

34. Portable object including a transponder according to any of claims 29 to 33.

35. Portable object according to claim 34, characterised in that it includes means for entering a personal identification code or means for measuring a biometric parameter in order to protect access to said application data stored in said transponder (1).
